(19) United States
(12) Patent Application Publication
(10) Pub. No.: US 2026/0081500 A1
(43) Pub. Date: Mar. 19, 2026

(54) Electrical Propulsion Assembly

(71) Applicant: ZF Friedrichshafen AG, Friedrichshafen (DE)

(72) Inventors: Hans-Georg Kneidinger, Untergriesbach (DE); Maximilian Schmitt, Eltmann (DE); Niklas Hock, Schonungen (DE); Michael Griesbach, Tettnang (DE)

(21) Appl. No.: 19/332,516

(22) Filed: Sep. 18, 2025

(30) Foreign Application Priority Data
Sep. 18, 2024 (DE) 102024208895.1

(51) Int. Cl. H02K 5/173; F16C 41/00

(52) U.S. Cl. CPC H02K 5/1732; F16C 41/002; F16C 2380/26

(57) ABSTRACT

An electrical propulsion assembly for a motor vehicle includes an electric machine having a rotor shaft, further includes a guide element which is electrically conductive and nested with the rotor shaft, and includes at least one damping member. The at least one damping member is closed in a circumferential direction and surrounds one or both of the guide element or the rotor shaft. The at least one damping member is configured to damp interference currents via one or both of a voltage induced in the at least one damping member by the interference currents or an electrical resistance of the at least one damping member, with the interference currents being generated during operation of the electrical propulsion assembly.

### CROSS-REFERENCE TO RELATED APPLICATION

The present application is related and has right of priority to German Patent Application No. 10 2024 208 895.1 filed on Sep. 18, 2024, the entirety of which is incorporated by reference for all purposes.

### FIELD OF THE INVENTION

The invention relates generally to an electrical propulsion assembly, in particular for a motor vehicle, including an electric machine with a rotor shaft and at least one electrically conductive guide element, wherein the rotor shaft and the guide element are nested one inside the other.

### BACKGROUND

Electrical drive assemblies, in particular for motor vehicles, which have an electric machine with a rotor shaft and at least one electrically conductive guide element, wherein the rotor shaft and the guide element are nested one inside the other, are known in principle from the prior art. It is also known from the prior art that a clocked operation of an inverter of the electrical propulsion assembly results in common mode currents or common mode voltages as high-frequency excitation. These cause interference currents in the electrical propulsion assembly, which can become noticeable as bearing currents and electromagnetic radiation and, therefore, can negatively affect the propulsion assembly.

One form of such bearing currents, in particular when using new inverter technologies (SiC, GaN), in connection with comparatively high parasitic capacitances, specifically in larger electric machines and/or hairpin windings, are circular bearing currents. Such bearing currents damage roller bearings of the electrical propulsion assembly, which bearings support, for example, the rotor shaft and/or the guide element, such that these bearings become mechanically impaired or acoustically conspicuous.

In order to avoid such bearing currents, it is known to reduce the above-described common mode currents by the greatest extent possible, in order to thus also reduce the circular magnetic field, which induces the circular bearing currents in the propulsion assembly. Alternatively, it is known to interrupt the current path for the bearing currents whenever possible, for example, by non-conductively coating different regions of the electrical propulsion assembly or by using ceramic bearings, in order to thus avoid conducting current through the bearings. This can result, for example, in a displacement of the problem, however, since the interruption can cause higher static voltages to form over the bearing. In addition, a further current path can form, for example, over a bearing, even when a certain current path is interrupted, such that the current path merely locally shifts, but forms nevertheless.

### SUMMARY OF THE INVENTION

The problem addressed by the invention is that of providing an electrical propulsion assembly which is improved by comparison and in which an occurrence of circular bearing currents is prevented in an improved way.

As described above, the invention relates to an electrical propulsion assembly, specifically for a motor vehicle. The electrical propulsion assembly includes an electric machine. The electric machine is, in particular, a traction drive for the motor vehicle. This means that the electric machine is designed to generate a torque for propelling the motor vehicle. The electric machine has a rotor shaft and at least one electrically conductive guide element, which are nested one inside the other. This means, in particular, that the electrically conductive guide element is arranged within an installation space which is delimited by the rotor shaft. For example, the rotor shaft is a hollow shaft and the electrically conductive guide element are guided through the hollow space or engage into the hollow space at least in sections. Alternatively, the electrically conductive guide element delimits a hollow space in which the rotor shaft is arranged, at least in sections. Specifically, the guide element and the rotor shaft are coaxially arranged.

The invention is based on the finding that the electrical propulsion assembly has at least one damping member, which is closed in the circumferential direction and surrounds at least the guide element and/or the rotor shaft and which is designed to damp interference currents, in particular bearing currents, generated during operation of the electrical propulsion assembly, by a voltage induced in the damping member by the interference currents and/or by an electrical resistance of the damping member. In other words, a damping member is arranged at least around the guide element and/or around the rotor shaft. The damping member is closed in the circumferential direction, for example, as a ring or band, which is closed around or arranged on the guide element and/or on the rotor shaft. The damping member is an electrical impedance and is electrically insulated with respect to the guide element or the rotor shaft on which it is arranged.

If, for example, a circular magnetic field arises, which forms due to common mode currents, a damping magnetic field is generated in the damping member due to circular bearing currents. The damping magnetic field induces a voltage over the guide element, or the rotor shaft, which, according to Lenz's law, counteracts the generation of the circular bearing currents and correspondingly damps these. Alternatively, a current is induced in the damping member, which is damped by an electrical resistance of the damping member. Advantageously, therefore, due to the provision of the damping member, the impedance of the interference current path, for example, of bearing currents, in particular of circular bearing current paths, is increased and, as a result, the interference currents is reduced, such that it is not necessary to provide further mechanisms for reducing the excitation due to the common mode current, for example, common mode chokes, and/or for interrupting the current paths of the circular bearing currents, for example, coatings, ceramic bearings, and the like. Instead, the circular bearing currents are reduced, such that these cannot also form at further points of the electrical propulsion assembly.

The electrical propulsion assembly may also be further developed such that the at least one damping member is arranged on the rotor shaft on an input side of the laminated core of the rotor and/or the at least one damping member is arranged on the rotor shaft on an output side of the laminated core of the rotor. Depending on which region of the electrical propulsion assembly is to be damped by the damping member, the damping member is arranged in the corresponding region. In principle, combinations of different arrangements of damping members are also possible, wherein one damping member is arranged on the rotor shaft on the input side of the laminated core and one damping member is arranged on the rotor shaft on the output side of the laminated core.

For example, the individual damping members by themselves are thus dimensioned smaller than would be necessary if a single damping member were used. As a result, for example, available installation spaces in the electrical propulsion assembly are utilized in an improved manner. The at least one damping member may also be integrated into at least one functional component of the propulsion assembly, for example, a bearing or a grounding element.

In a further embodiment of the electrical propulsion assembly, the at least one damping member is arranged on the guide element on an input side of the rotor of the electric machine and/or the at least one damping member is arranged on the guide element on an output side of the rotor. As an alternative to, or in addition to, the above-described arrangement of the at least one damping member on the rotor shaft, the at least one damping member may also be arranged on the guide element. It is possible in turn to arrange the damping member on the guide element on the input side of the rotor or to arrange the damping member on the output side of the rotor. Any combination with the above-described arrangements is possible, such that such a damping member can be arranged, for example, on the guide element on the input side of the rotor and/or on the guide element on the output side of the rotor and/or on the rotor shaft on the input side of the laminated core and/or on the rotor shaft on the output side of the laminated core. The individual damping members may be identical or different in all described combinations.

In principle, each damping member can be designed as desired, provided this is designed to damp the described interference currents, for example, the circular bearing currents and/or also further interference currents flowing on the surrounded elements, such as the rotor shaft and/or the guide element, for example, rotor-ground currents or discharge currents. In one embodiment of the electrical propulsion assembly, the at least one damping member resistively and/or inductively damps interference currents. The damping member damps, for example, by an ohmic resistance, i.e., resistively. For this purpose, a current is induced, for example, in the damping member by the circular magnetic field, which current is damped or decreased via a resistance in the damping member. Alternatively, it is also possible to inductively damp the interference currents, for example, on the basis of a damping magnetic field generated in the damping member by the interference currents, which damping magnetic field induces a voltage directed opposite to the interference current. For example, the resistance for high-frequency currents may be increased by the damping member. As a result, additional resistance is introduced into the path that the interference currents, for example, the circular bearing currents, can take, such that the formation of interference currents is effectively prevented or at least reduced.

In a further embodiment of the electrical propulsion assembly, the at least one damping member is a toroidal tape core. As described above, the damping member is specifically placed or arranged around a potentially conductive path and, in this way, the impedance for high frequencies of the current is increased. A “toroidal tape core” is understood to be, in particular, an annular band, in particular made of nanocrystalline material and/or wound iron sheet and/or ferrite material and/or sintered ceramic.

Furthermore, in the electrical propulsion assembly, the at least one damping member is arranged on the rotor shaft and/or the guide element for conjoint rotation or in a stationary manner. For example, if the damping member is connected to the rotor shaft for conjoint rotation, the damping member carries out the rotational motion of the rotor shaft together with the rotor shaft. Similarly, the guide element is a rotatable component of the electrical propulsion assembly or as a stationary component of the electrical propulsion assembly, wherein, when the damping member is connected to the guide element for conjoint rotation, the damping member can rotate together with the guide element.

As an alternative to the above-described possible arrangements, the damping member may be stationarily arranged in each case, for example, fixedly connected to a housing. In this case, the damping member is nevertheless arranged around the guide element and/or the rotor shaft but does not rotate together with the guide element or the rotor shaft, and instead remains stationary with respect thereto. Any manner of corresponding combinations of rotating and stationary damping members are possible in the above-described possible arrangements on the rotor shaft and the guide element. As described above, in any case, the damping member is electrically insulated with respect to the component on which it is arranged. This means that electrical insulation exists between the damping member and the rotor shaft or the damping member and the guide element.

As described above, the guide element is, in principle, a stationary or a rotating part. In one embodiment of the electrical propulsion assembly, the guide element is a shaft, in particular an output shaft, or an element fixed to the housing, in particular a grounding or a cooling line. The guide element is, for example, a shaft of the electrical propulsion assembly and guided through or engaged in the hollow space delimited by the rotor shaft, at least in sections. For example, the shaft is an input shaft or an output shaft. Alternatively, the guide element is an element fixed to the housing.

For example, the guide element is a grounding lance, or a cooling line, in particular an oil lance, or oil tube, for conducting any other type of coolant. In this case, the guide element does not carry out a rotational motion, but rather is stationarily coupled to the housing. In the electrical propulsion assembly, more than one guide element can also be provided. For example, a first guide element is arranged within the hollow space delimited by the rotor shaft, wherein a second guide element is guided within the first guide element. The first guide element is, for example, an output shaft, and the second element is a supply device, for example, a grounding lance or an oil lance.

Furthermore, in the electrical propulsion assembly, the at least one damping member can be designed to damp interference currents, specifically circular bearing currents, in accordance with at least one shielding of the guide element. Advantageously, in the described embodiment, the effect of the damping member is coupled to the generation of circular bearing currents. If, for example, the electrical propulsion assembly is shielded by a shielding of the rotor shaft and/or of the guide element, no circular bearing currents are generated. In this state, the damping member also does not operate. Therefore, the damping member operates only when circular bearing currents are also excited, which are then damped by the damping member as described above.

In other words, the damping by the damping member operates when shielding is not active or the shielding is not completely active. If the electrical propulsion assembly is, for example, in a state in which the rotor shaft and/or the guide element is shielded, for example, at comparatively low rotational speeds or when the bearings of the rotor shaft and/or of the guide element are not through-hole plated, the damping member does not induce damping or any effects that impair the operation of the electrical propulsion assembly.

In a further embodiment of the electrical propulsion assembly, the electrical propulsion assembly has at least one ceramic bearing, in particular for supporting the rotor shaft and/or the guide element, and/or the electrical propulsion assembly has at least one filter member. The above-described damping member, or the above-described damping members, are therefore combinable with the at least one ceramic bearing and/or the at least one filter member. For example, the filter member used may be an AC filter, in particular a common mode choke, in order to reduce electromagnetic radiation of the electrical propulsion assembly and to simultaneously reduce the above-described common mode currents. In combination with the measures provided in this embodiment, it is possible, for example, to dimension the damping member itself smaller.

In addition to the electrical propulsion assembly, the invention also relates to a motor vehicle which includes such an electrical propulsion assembly. The invention also relates to a method for reducing bearing currents in an electrical propulsion assembly, in particular for a motor vehicle, including an electric machine with a rotor shaft and at least one electrically conductive guide element, wherein the rotor shaft and the guide element are nested one inside the other, wherein, by at least one damping member, which is closed in the circumferential direction and surrounds at least the guide element and/or the rotor shaft, interference currents, in particular bearing currents, generated during operation of the electrical propulsion assembly are damped by a voltage induced in the damping member by the interference currents and/or by an electrical resistance of the damping member.

The method is carried out by the electrical propulsion assembly or on the electrical propulsion assembly, which was described above. All advantages, details, and features, which were described with respect to the electrical propulsion assembly, are completely transferrable to the motor vehicle which includes the electrical propulsion assembly.

### BRIEF DESCRIPTION OF THE DRAWINGS

The invention is explained in the following on the basis of exemplary embodiments with reference to the figures. The figures are schematic views and show:

FIG. 1 an elementary diagram of a cutout portion of an electrical propulsion assembly according to the prior art;

FIG. 2 an elementary diagram of a cutout portion of an electrical propulsion assembly according to a first aspects of an exemplary embodiment;

FIG. 3 an elementary diagram of a cutout portion of an electrical propulsion assembly according to a second aspects of an exemplary embodiment;

FIG. 4 an elementary diagram of a cutout portion of an electrical propulsion assembly according to a third aspects of an exemplary embodiment; and

FIG. 5 an elementary diagram of a cutout portion of an electrical propulsion assembly according to a fourth aspects of an exemplary embodiment.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

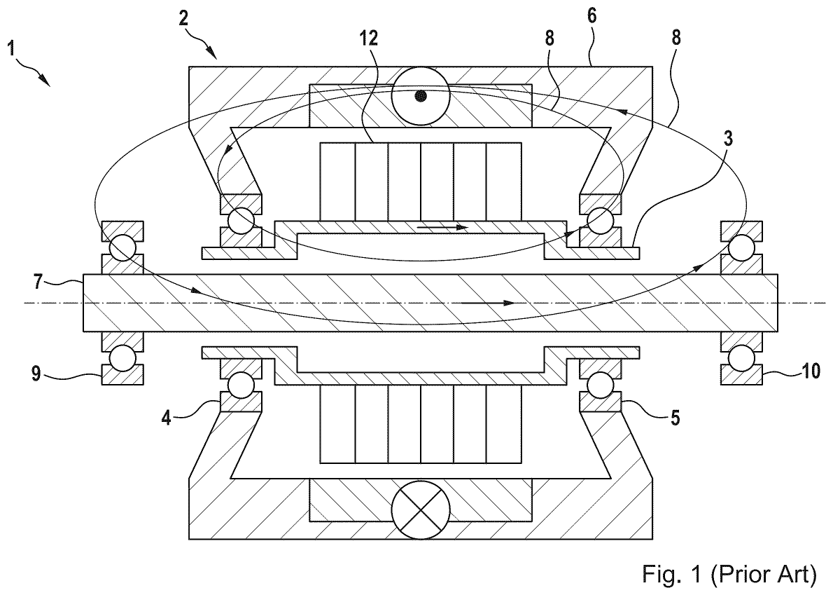

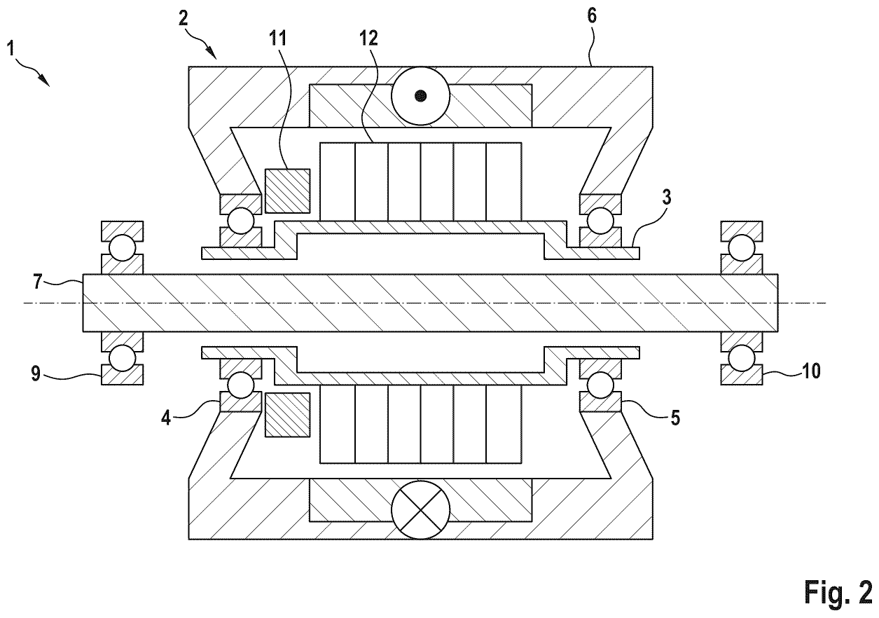

FIG. 1 shows a schematic view of an electrical propulsion assembly 1, for example, for a motor vehicle. The fundamental design of the electrical propulsion assembly 1 from FIG. 1 is also transferrable in the following to the exemplary aspects of embodiments described with reference to FIGS. 2-5. The propulsion assembly 1 has an electric machine 2, which includes a rotor shaft 3. The rotor shaft 3 is supported on a housing 6 of the electrical propulsion assembly 1 by bearings 4, 5. In addition, the electrical propulsion assembly 1 has an electrically conductive guide element 7, which is nested within the rotor shaft 3. The nested arrangement of the rotor shaft 3 and the guide element 7 is merely an example and may be vice versa or designed in another manner. In the described assembly, the guide element 7 is arranged, in particular, coaxially with the rotor shaft 3 and extends through a hollow space, which is delimited by the rotor shaft 3, which is a hollow shaft.

Due to the clocked operation of an inverter (not shown in greater detail) of the electrical propulsion assembly 1, a circular magnetic field arises in the electric machine 2, which is indicated in FIG. 1 with a dot “•” and an “X”. This yields the circular bearing currents, which are indicated as an arrow 8 and flow, for example, over the bearings 4, 5 or also bearings 9, 10 and, thus, potentially damage the bearings 4, 5, 9, 10.

FIG. 2 shows an electrical propulsion assembly 1 according to a first aspects of an exemplary embodiment. In the electric machine 2 of the electrical propulsion assembly 1, a damping member 11 is arranged around the rotor shaft 3 and the guide element 7. The damping member 11 is closed in the circumferential direction, i.e., is annular. Specifically, the damping member 11 is a toroidal tape core. For example, the damping member 11 in FIG. 2 is arranged on the rotor shaft 3, or around the rotor shaft 3, on an input side of a laminated core 12. The laminated core 12 refers, in particular, to the rotor laminated core of the rotor on the rotor shaft 3. Correspondingly, bearing currents over the bearings 4, 5, 9, 10 are damped. For the positioning of the damping members 11 in the exemplary embodiment according to FIGS. 2-5 around the rotor shaft 3 and/or the guide element 7, it is important to note that all shafts or generally conductive components surrounded by the damping member 11 benefit from the damping. Therefore, there are different use positions for the damping members 11 in order to generally considerably reduce current flow on shafts or conductive components.

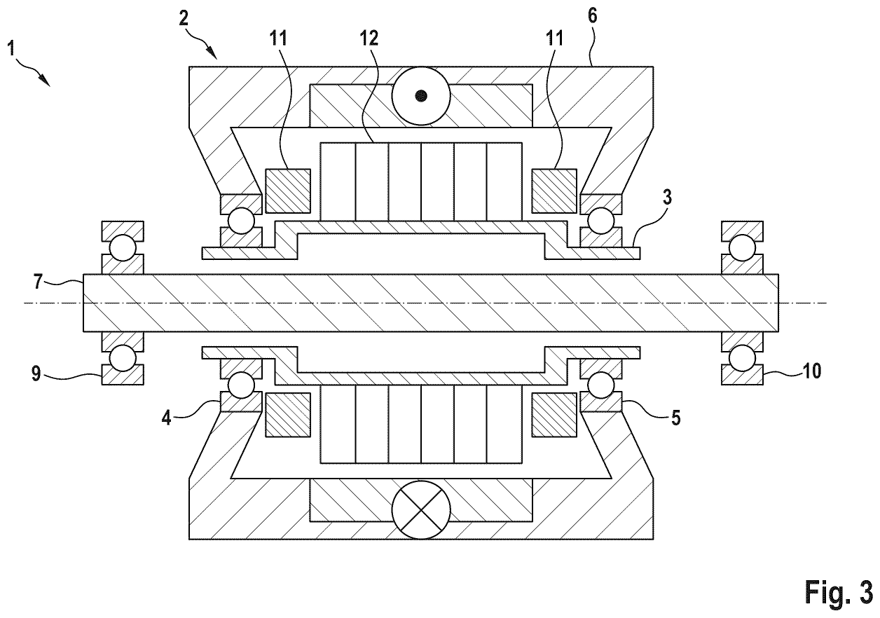

Instead of the arrangement of the damping member 11 on the input side of the laminated core 12, which is shown in FIG. 2, an arrangement which is opposite in the axial direction, i.e., on the output side of the laminated core 12, is also possible. FIG. 3 shows, for example, an arrangement of two damping members 11, wherein the first damping member 11 is arranged on the rotor shaft 3 on the input side of the laminated core 12 and a second damping member 11 is arranged on the rotor shaft 3 on the output side of the laminated core 12. In any case, electrical insulation exists between the damping member 11 and the machine element on which, at which, or around which the damping member 11 is arranged. In the present case, the damping member 11, or the damping members 11, is/are electrically insulated with respect to the rotor shaft 3.

Generally, in all exemplary embodiments, the damping members 11 cause interference currents to be reduced. For example, due to the circular bearing currents induced by the circular magnetic field, a damping magnetic field is induced in the damping members 11 and, therefore, an oppositely directly voltage is induced, which counteracts the circular bearing currents, such that the circular bearing currents are prevented or at least damped. Alternatively, it is also possible that one or more of the damping members 11 includes an electrical resistance. If a current is induced in the damping member 11 by interference currents, for example, due to inductive coupling of the circular bearing currents, the damping member 11, for example, as a loop placed around the rotor shaft 3 and/or the guide element 7, reduces the induced current by an ohmic resistance.

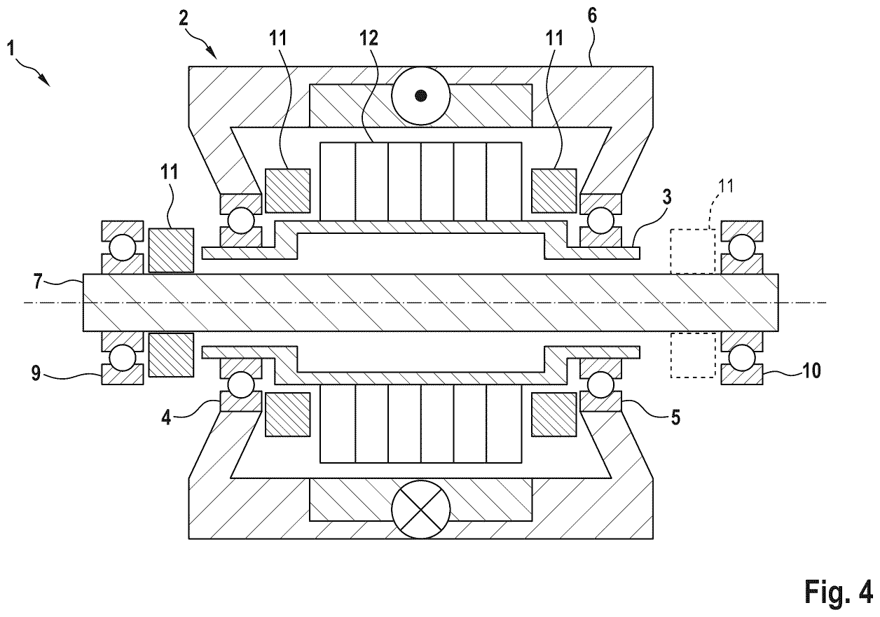

FIG. 4 shows a further exemplified assembly, which can be combined, for example, with the above-described assemblies. A further or third damping member 11, which is arranged on the guide element 7, is shown. Electrical insulation exists, in turn, between the damping member 11 and the guide element 7. Although the damping members 11 are additionally shown on the rotor shaft 3, these may be omitted in this embodiment or only one of the damping members 11 may be provided on the rotor shaft 3, for example, only the input-side damping member 11, which is shown in FIG. 2, or the output-side damping member 11, described in FIG. 3. Instead of arranging the damping member 11 on the input side of the guide element 7, the damping member 11 may instead be arranged on the output side of the guide element 7, i.e., on the side which is opposite in the axial direction. In addition, a combination of damping members 11 on the guide element 7 is also possible, such that the damping member 11 is arranged on the input side and an additional or fourth damping member 11 is arranged on the output side, as shown in dashed lines.

The possibilities for arranging damping members 11, which are described by example herein, can be combined with one another as desired, such that at least one damping member 11 is arranged on the guide element 7 on the input side and/or a damping member 11 is arranged on the rotor shaft 3 on the input side and/or a damping member 11 is arranged on the output side of the rotor shaft 3 and/or a damping member 11 is arranged on the output side of the guide element 7.

In the exemplary embodiments shown in FIGS. 2-5, the damping members 11 are either fixed to the housing, i.e., do not concurrently rotate with rotating machine components on which or around which they are arranged, or are fixedly arranged on the rotor shaft 3 or the guide element 7, such that they concurrently carry out the rotational motion of the guide element 7 or the rotor shaft 3. Purely by way of example, the guide element 7 itself is a rotatable machine element, for example, an input shaft or an output shaft. Alternatively, it is also possible that the guide element 7 is fixed to the housing or is stationary, for example, a supply element, in particular, an oil lance and/or a grounding lance.

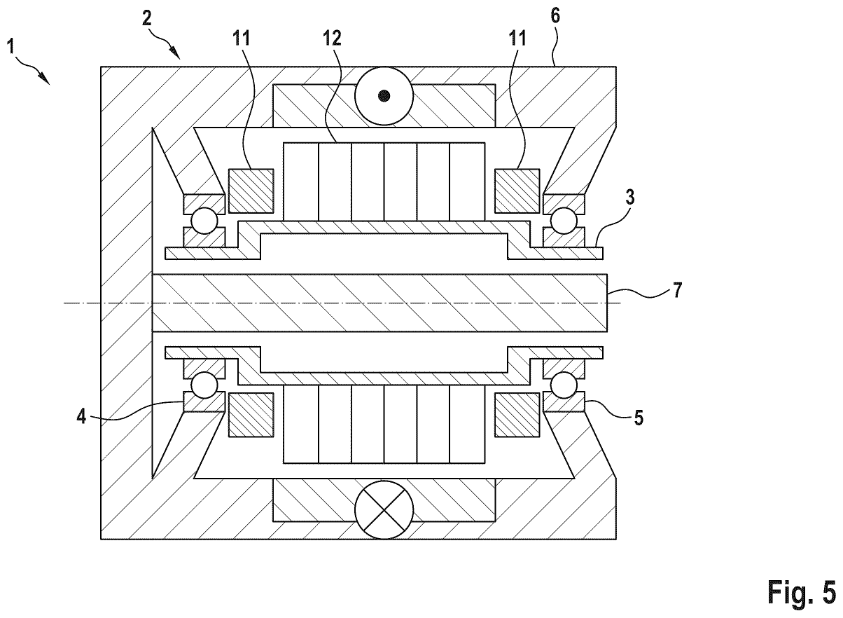

FIG. 5 shows, by way of example, a stationary arrangement of the guide element 7. The stationary arrangement of the guide element 7 is combinable with the preceding aspects of exemplary embodiments, such that each of the guide elements 7 in FIGS. 2-4 is instead a stationary guide element 7. The possible arrangements of the damping members 11 are correspondingly also transferrable to the embodiment in FIG. 5.

Purely by way of example, FIG. 5 shows an arrangement of damping members 11 on the rotor shaft 3, namely on the input side and on the output side. Any other combinations of damping members 11 are also possible. In this embodiment, the damping members 11 on the rotor shaft 3 also act on the stationary guide element 7 within the hollow space, which is delimited by the rotor shaft 3. The guide element 7 is, for example, an oil lance and/or a grounding lance.

Very generally, the guide element 7 is understood to be any electrically conductive component which extends within the rotor shaft 3 and is affected by the induced voltage in response to the circular magnetic field. As a result, a circular current flow may also arise on these components, which is then reduced by using damping members 11, in particular toroidal tape cores (for example, ferrites or nanocrystalline material). If the aim is to reduce only the current in the radially internal component, i.e., for example, the guide element 7, at least one damping member 11 is arranged only around the internal component, for example, the damping member 11 on the guide element 7 in FIG. 4, where the further damping members 11 shown in FIG. 4 are correspondingly omitted.

In general, it is also possible to also use the damping members 11 around other shafts outside the two bearings 4, 5. As a result, the damping effect is also limited only to this surrounded shaft and no longer to the rotor shaft 3, however. This may also be carried out in combination with other arrangement positions, such that the damping properties overlap in certain regions and, thus, individual damping members 11 are dimensioned smaller.

Furthermore, a grounding element may be arranged on the guide element 7. The grounding element may be arranged, for example, on the outer surface of the guide element 7 or on the guide element 7 between the guide element 7 and the rotor shaft 3. This is a possible integration, such that, during operation, a grounding element is combined with the damping member 11 or a grounding path is damped by this damping member 11.

The advantages, details, and features described in the individual exemplary embodiments are arbitrarily combinable with one another, interchangeable with one another, and transferrable to one another. The description is in turn also transferrable to a motor vehicle which includes an electrical propulsion assembly 1 according to FIGS. 2-5. The electrical propulsion assembly 1 is usable to carry out the method described herein. The description is therefore also completely transferrable to the method.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 electrical propulsion assembly
2 electric machine
3 rotor shaft
4, 5 bearing
6 housing
7 guide element
8 arrow
9, 10 bearing
11 damping member
12 laminated core

1-11 (canceled)

12. An electrical propulsion assembly (1) for a motor vehicle, comprising:
an electric machine (2) comprising a rotor shaft (3);
a guide element (7), the guide element (7) being electrically conductive, the guide element (7) being nested with the rotor shaft (3); and
at least one damping member (11), the at least one damping member (11) being closed in a circumferential direction and surrounding one or both of the guide element (7) or the rotor shaft (3), the at least one damping member (11) being configured to damp interference currents via one or both of a voltage induced in the at least one damping member (11) by the interference currents or an electrical resistance of the at least one damping member (11), the interference currents being generated during operation of the electrical propulsion assembly (1).

13. The electrical propulsion assembly (1) of claim 12, wherein a rotor of the electric machine (2) comprises a laminated core (12),
wherein the at least one damping member (11) includes one or both of a first damping member on the rotor shaft (3) on an input side of the laminated core (12) or a second damping member on the rotor shaft (3) on an output side of the laminated core (12).

14. The electrical propulsion assembly (1) of claim 12, wherein the at least one damping member (11) comprises one or both of a third damping member on the guide element (7) on an input side of a rotor of the electric machine (2) or a fourth damping member on the guide element (7) on an output side of the rotor.

15. The electrical propulsion assembly (1) of claim 12, wherein the at least one damping member (11) at least one of resistively or inductively damps circular bearing currents of the interference currents.

16. The electrical propulsion assembly (1) of claim 12, wherein the at least one damping member (11) comprises a toroidal tape core.

17. The electrical propulsion assembly (1) of claim 12, wherein the at least one damping member (11) is either coupled for conjoin rotation with or stationary relative to the one or both of the guide element (7) or the rotor shaft (3).

18. The electrical propulsion assembly (1) of claim 12, wherein the guide element (7) is a rotatable shaft or an element fixed to a housing.

19. The electrical propulsion assembly (1) of claim 18, wherein the element fixed to the housing is a grounding line or a cooling line.

20. The electrical propulsion assembly (1) of claim 12, wherein the at least one damping member (11) damps circular bearing currents of the interference currents based on shielding of the guide element (7).

21. The electrical propulsion assembly (1) of claim 12, further comprising one or both of:
at least one ceramic bearing for supporting at least one of the rotor shaft (3) or the guide element (7); or
at least one filter member.

22. The electrical propulsion assembly (1) of claim 12, wherein the damp interference currents are bearing currents.

23. A motor vehicle, comprising the electrical propulsion assembly (1) of claim 12.

24. A method for reducing bearing currents in an electrical propulsion assembly (1) for a motor vehicle, the electrical propulsion assembly (1) comprising an electric machine (2) with a rotor shaft (3), the electrical propulsion assembly (1) further comprising a guide element (7), the rotor shaft (3) and the guide element (7) being nested, the guide element (7) being electrically conductive, the method comprising:
providing at least one damping member (11), the at least one damping member (11) being closed in a circumferential direction and surrounding one or both of the guide element (7) or the rotor shaft (3), interference currents being damped via one or both of a voltage induced in the at least one damping member (11) by the interference currents or an electrical resistance of the at least one damping member (11) the interference currents being generated during operation of the electrical propulsion assembly (1).
